(19) United States
(12) Patent Application Publication
(10) Pub. No.: US 2022/0228355 A1
(43) Pub. Date: Jul. 21, 2022

(54) ODOUR-EXTRACTION SYSTEM FOR A CENTRAL SINGLE-PURPOSE OR CENTRAL MULTIPURPOSE SINGLE- OR MULTIPLE-TOILET ARRANGEMENT

(71) Applicant: Martin Mesa Espinel, Neiva (CO)

(72) Inventor: Martin Mesa Espinel, Neiva (CO)

(21) Appl. No.: 17/436,632

(22) PCT Filed: Mar. 5, 2020
(86) PCT No.: PCT/IB2020/051928

§ 371 Date: Apr. 7, 2022

(30) Foreign Application Priority Data
Mar. 5, 2019 (CO) NC2019/0002114

(51) Int. Cl. E03D 9/052; B01D 45/16

(52) U.S. Cl. CPC E03D 9/052; B01D 45/16

(57) ABSTRACT

The present invention refers to an unpleasant odor evacuation system applicable to toilets of a public nature (offices, shopping centres, means of transport, hotels, restaurants) or private (houses, apartments, apartment buildings). The system of the present invention has a functional version for an individual toilet, a centralized version for multiple toilets, the latter with a single purpose (evacuation of odors from the bathroom) or multipurpose (evacuation of odors from the toilet and elimination of odors, dust, or particles from areas other than the bathroom).

### CROSS REFERENCE TO RELATED APPLICATION

This application is a national stage entry of PCT/IBP2020/051928 filed Mar. 5, 2020, under the International Convention claiming priority over Colombian Patent Application No. NC2019/0002114 filed Mar. 5, 2019.

### TECHNICAL FIELD

The present invention is developed in the field of civil engineering, specifically at area the design of systems electrical and mechanics from extraction of air.

### BACKGROUND FROM THE INVENTION

Some of the first attempts to solve the technical problem posed (handling bad odors) consisted of masking or neutralizing said odors through various flavoring and/or deodorizing agents that could be applied manually or through devices or systems that allowed automatic application of said agents.

It is clear that these types of strategies are not a sufficient solution given that many times the flavoring or deodorizing agents do not manage to completely mask said bad odors, and in addition, the permanent use of these agents also implies a continuous purchase and refiling after their exhaustion.

Various ventilation systems, ranging from an architecture that provides a design that allows the circulation of fresh air, to a wide variety of mechanical, electric, and electronic systems, that seek continuous air circulation in the space where bad odors are produced, they have been used to try to extract bad odors related to the use of bathrooms. However, these systems, which many be sufficient in private individual bathrooms (as in some homes), are not sufficient in shared or public spaces, where the same area of the bath can be used by several people at the Same time.

Some of these systems work permanently and others are activated during or after the use the toilet. These various ventilation systems are characterized in that their main objective is to change a certain volume of air over time. In other words, these systems do not seek to act directly on the source or origin of said bad odours.

Other systems of this same type have a variation in their design that allows them to perform a localized evacuation and even activate at the very moment when that bad odor can be generated, systems that work like an “extraction hood”. However, this type of system does not act on the very source of the bad odour, so its efficiency is reduced.

Other type of developments in this sense involves devices directly to the toilet, either in the bowl, the tank or as an additional accessory to be installed in some part of the toilet system. Other developments propose a particular toilet design that involves the odor extraction system.

Most of these on-site extractors work individually for a single odorless system and most of the time they do not use the standard design of a conventional odorless system to involve the extraction system, using additional accessories. Likewise, these systems usually need to interrupt the mechanism for the extraction of odors when the cistern is discharger for the evacuation of water through the pipe.

None of these systems uses the vacuum principle for the extraction of the bad odors, nor does it take advantage of the conventional and standardized structure of conventional toilets systems, nor can they vary their operation for individual or multiple toilet systems, nor do they allow seamless integration. Through a central extraction system that can be uni-purpose (extract only odors from the bathroom) or multi-purpose (extract bad odors from the bathroom while at the same time extracting odours, dust or particulate matter from other roomslike a vacuum cleaner).

### SUMMARY OF THE INVENTION

The Present invention refers to an unpleasant odor evacuation system applicable to toilets of a public nature (offices, shopping centers, means of transport, hotels, restaurants) or private (houses, apartments, apartment buildings). The system of the present invention has a functional version for an individual toilet, a centralized version for multiple toilets, the latter with a single purpose (evacuation of odors from the bathroom) or multipurpose (evacuation of odors from the toilet and elimination of odors, dust, or particles from areas other than the bathroom).

### DESCRIPTION OF THE FIGURES

FIG. 1A. It presents a section view of a toilet with a cistern tank, which has the odor extraction system with an individual type of vacuum unit (10A), object of the invention. The main components and their configuration are shown.

FIG. 1B. It presents a section view of a toilet with a cistern tank, which has the odor extraction system with a central type of vacuum unit (10B), object of the invention. The main components and their configuration are shown.

FIG. 2A. FIG. 2A. Presents a cutaway view of a toilet without a cistern tank, which has the odor extraction system with an individual type of vacuum unit (10A), object of the invention. The main components and their configuration are shown.

FIG. 2B. Presents a cutaway view of a toilet without a cistern tank, which has the odor extraction system with a central type of vacuum unit (10B), object of the invention. The main components and their configuration are shown.

FIG. 3A. It presents a sectional view of the individual type of vacuum unit (10A), object of the invention. It shows the main components and their configuration. The vacuum unit (10A) is responsible for generating the vacuum effect that triggers odor extraction.

FIG. 3B. It presents a sectional view of the central type of vacuum unit (10B), object of the invention. It shows the main components and their configuration. The vacuum unit (10) is responsible for generating the vacuum effect that triggers the extraction of odours.

FIG. 4. Presents a sectional view of the suction nozzle (6), object of the invention. It shows the main components and their configuration. The main function of the suction nozzle (6) is to transmit the suction effect to the tanker above the water level.

FIG. 5. Presents a sectional view of the suction T (24), object of the invention. It shows the main components and their configuration. The main function of the suction T (24) is to allow alternating between the suction of odors and the discharge of water in a toilet without a cistern tank.

FIG. 6. Presents a sectional view of the odor extraction and dust absorption system, object of the invention, with a Dual-type vacuum unit (10C). The main components and their configuration are shown.

FIG. 7. Presents a sectional view of the Dual vacuum unit (10C), object of the invention. It shows the main components and their configuration. The Dual vacuum unit (10) is responsible for generating the vacuum effect that triggers the extraction of odors and the absorption of dust and particles.

### DETAILED DESCRIPTION OF THE INVENTION

The system disclosed below allows the effective extraction of focused odours, dust and particles together or independently.

The system uses the suction effect generated in the vacuum unit. The vacuum unit has an electric motor and a suction turbine. In addition to ducts, a manual or automatic star and stop system, suction and discharge points, noise reduction system, suction nozzle, solenoid valves, dust and particle suction points, hoses and dust and particle suction systems, particle and dust separator, filters.

Next, each of the extraction systems is described in detail, as well as the main components that correspond to this invention.

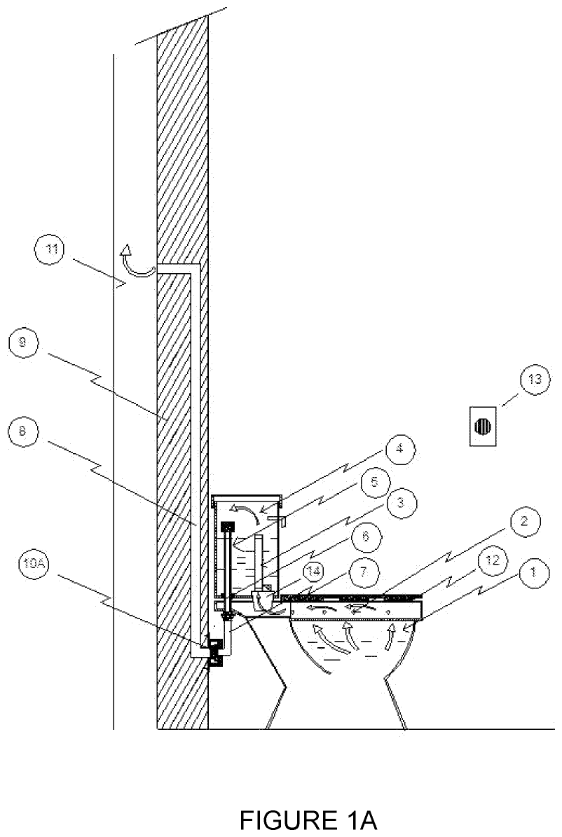

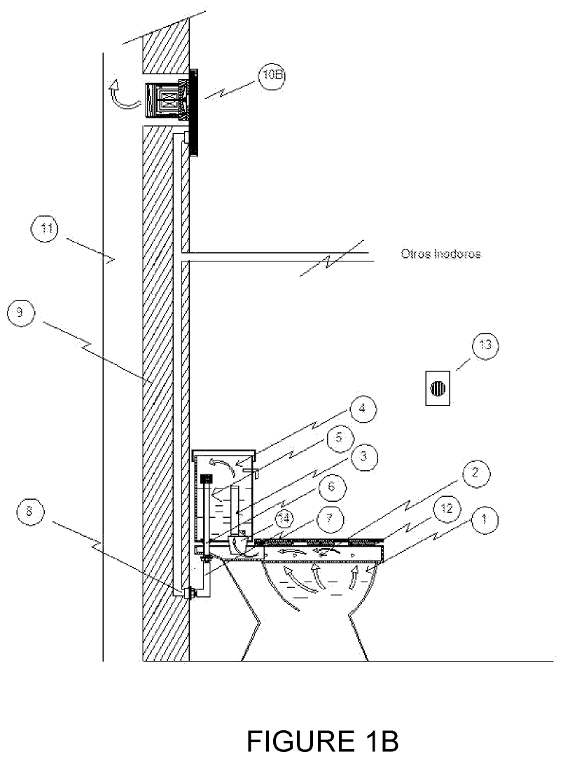

In a first embodiment of the odor extraction system (FIGS. 1, FIG. 2A, FIG. 2B, FIG. 3A, FIG. 3B, FIG. 4 and FIG. 5), characterized in that it allows the evacuation of unpleasant odors resulting from human defecation in the toilet rooms, in a novel, effective, practical way and with minimal modifications to the structure of the toilet. Without changing its appearance and asepsis. Preventing the spread of unpleasant odors both in the toilet room and nearby areas and benefiting both the user who is using the toilet and those who are in the nearby areas. Odor extraction can be performed with individual or central type units, as described below.

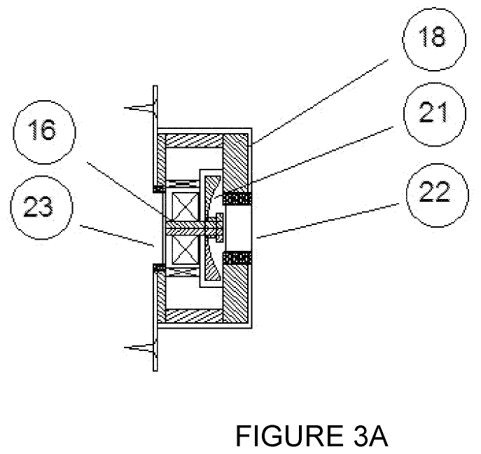

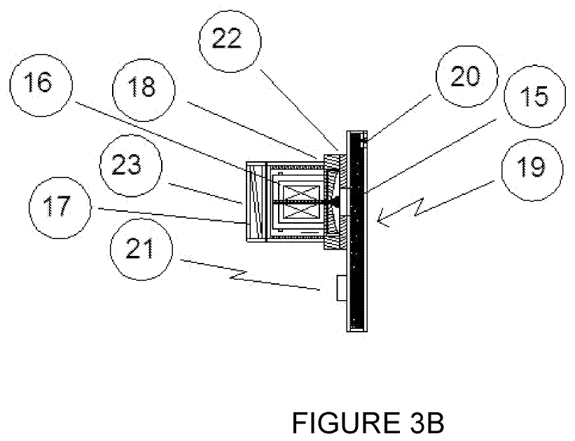

The individual vacuum unit (FIG. 3A), is characterized in that the odor extraction system disclosed here can have an individual vacuum unit (10A),composed of a high-rev electric motor (16) and a vacuum turbine (18), which generates a low-pressure effect towards the suction (21), where the suction ducts (8) are connected. At the back of the empty turbine (18), the odor discharge area is located towards the air evacuation ducts (11), passing through the discharge (23). The individual vacuum unit (10A) is controlled by an on/off system (13), which can operate automatically or manually.

There is also the Central vacuum unit (FIG. 3B), characterized in that the odor extraction system disclosed here has a vacuum unit (10), made up of a high-rev electric motor (16) and a vacuum turbine (18), a low-pressure section called suction chamber (15), which transmits the vacuum effect to the suction (21), where the suction ducts (8) are connected. In the suction chamber (15) noise is also controlled and suction regulation is carried out by means of the pressure equalizing valve (20), which facilitates the passage of water through the discharge valve. (14), during the discharge of water of the tank (4). At the back of the empty turbine (18), the odor discharge area is located towards the air evacuation ducts. (11), passing through the discharge noise reduction system (17) and the discharge (23). The simple vacuum unit (10) is controlled by an on/off system (13), which can operate automatically or manually.

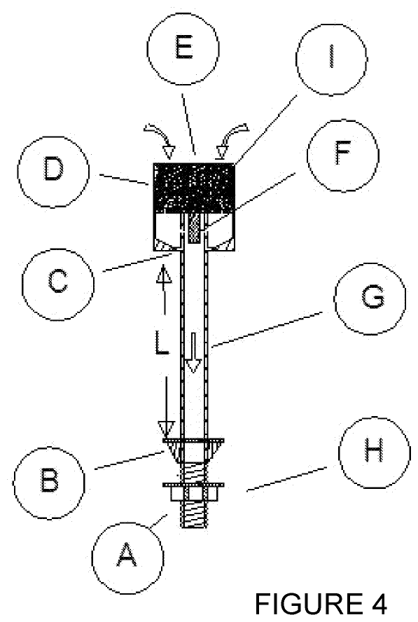

A suction nozzle (FIG. 4) (6), whose main functions are to transmit the suction effect of the individual or central vacuum unit (10A and 10B) to the tanker tank (4), reduce noise, reduce the humidity of the current of air extracted from the cistern tank (4). The suction nozzle (6) is installed in an additional hole in the bottom of the tank tank (4) and must have a height (L) greater than the maximum water level (5) inside the tank tank (4). It is made up of a vertical duct (G) that has a threaded lower end (A) that allows it to go through the bottom of the tanker tank (4) and provide a hermetic seal by adjusting the nut (H) against the gasket (B). At the upper end of the vertical duct (G) is the suction head (D) in which the air that generates the vacuum inside the cistern tank (4) is allowed to enter through the upper cover (E). Noise reduction is also made in the suction head by means of the noise filter and the aim is to reduce the humidity of the air current that enters the suction nozzle (6) by means of the sudden change of direction of the air current that enters to the vertical window (F). The water droplets are evacuated through the drainage holes (C).

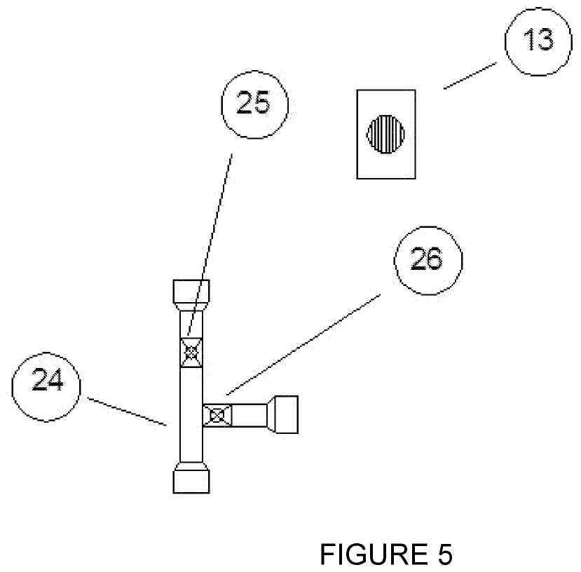

The system includes the suction T (FIG. 5) (24), whose main function is to allow alternating between the suction of odors and the discharge of water in a toilet without a cistern tank. The suction T (24) is made up of a T-shaped duct that houses 2 solenoid valves that operate in coordination with each other and in conjunction with the central vacuum unit (10B).

The suction solenoid valve is normally open and while the vacuum unit (10A or 10B) is in operation, the effect of suction and evacuation of odors from the toilet bowl (1) is generated. Once the user activates the discharge of water, the on/off system turns off the vacuum unit (10A or 10B) and closes the suction solenoid valve (25) and opens the discharge solenoid valve (26). Once the water discharge process is finished, the discharge solenoid valve (26) closes and the suction solenoid valve (25) return to the normally open position. In this way, the suction T (24) houses the solenoid valves that allow alternating between suction of odors and discharge of water. In addition, the suction tee allows to connect the water discharge, the air suction, and the discharge duct in a toilet without a cistern tank.

The odor extraction system disclosed here is described below according to the toilet model:

In a first embodiment, there is the extraction system for a toilet with a cistern tank (FIG. 1A, FIG. 1B, FIG. 3A, FIG. 3B and FIG. 4), which consists of an on/off system (13) that is activated when the user uses the toilet. Either by manual button or automatically by sensors. The vacuum unit (10A or 10B) comes into operation and generates the suction effect. The suction effect is transmitted through ducts (8), (7) and the suction nozzle (6) and to the toilet tank (4). Inside the cistern tank, a differential pressure effect is generated and is transmitted from the cistern tank (4) to the rate (1) of the toilet through the overload duct (3), the discharge valve (14), the compartments and/or or discharge holes (2) of the toilet bowl (1). This phenomenon occurs while the discharge valve (14) is closed, in such a way that there is no water inside the overload duct (3), nor in the compartments and/or holes (2) of the toilet bowl (1). When the user activates the flush valve (14), the water from the cistern flows towards the toilet bowl (1) through the flush valve (14), the compartments and/or flush holes (2) of the toilet fee (1). The flushing process lasts approximately 5 seconds, during which time the pressure equalizing valve (20) is activated, which regulates the suction effect allowing normal operation of the toilet flush, the vacuum unit (10A or 10B) continues to operate, and it turns off temporarily approximately 2 minutes after the water is discharged. Once the vacuum unit (10A or 10B) is turned off, the process can start over. In this way it is possible to remove the odors from the source and evacuate them to the outside.

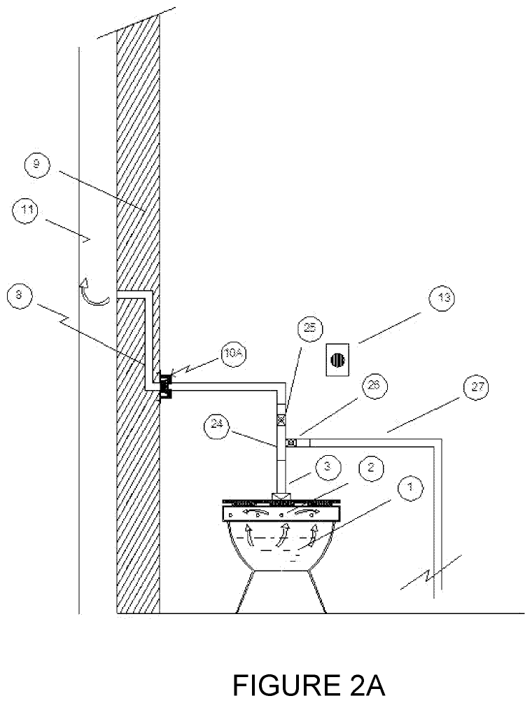

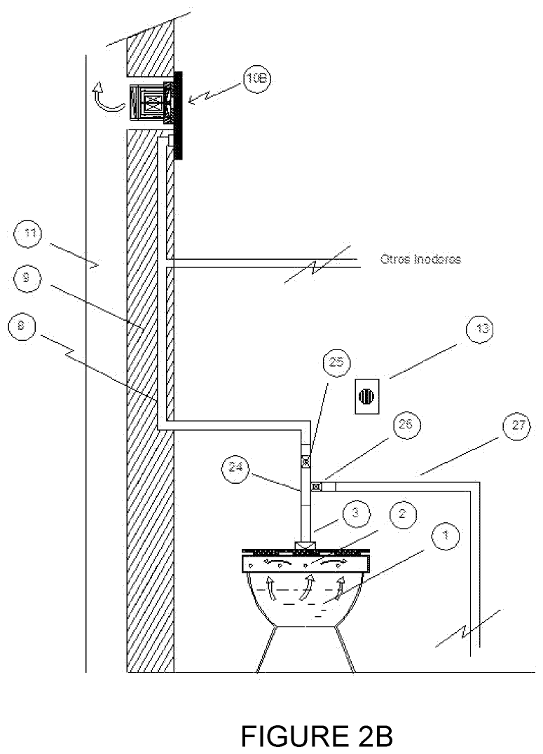

In a second embodiment is the Toilet without a cistern tank (FIG. 2A, FIG. 2B, FIG. 3A, FIG. 3B and FIG. 5). An on/off system (13) is activated when the user uses the toilet, either by manual button or automatically by a sensor. The vacuum unit (10A or 10B) comes into operation and generates the vacuum effect, the vacuum effect is transmitted through the suction ducts (8) to the suction T (24) where the suction solenoid valve (25) is located.), which is normally open and transmits the suction effect to the discharge duct suction ducts (8) with the water discharge ducts (5) and allows housing the solenoid valves (25) and (26). The vacuum effect is transmitted to the toilet bowl (1) through the discharge duct (3), compartments and/or internal washing holes (2) in the toilet bowl (1), to where the source of the odor is. This phenomenon occurs while the discharge electro valve is normally closed, in such a way that there is no water inside the discharge tube (3), the compartments and/or internal holes (2) for flushing the toilet bowl (1). When the user discharges water, the electronic system turns off the vacuum unit (10A or 10B), closes the suction solenoid valve (25) and opens the discharge solenoid valve (26) synchronously. The suction T (24) allows to isolate the suction duct (8) and enable water discharge, so that the water flows towards the toilet bowl (1) through the discharge duct (3), the compartments and/or internal holes (2) for flushing the toilet bowl (1). The water discharge process lasts about 5 seconds, time in which the odor extraction operation is suspended, then the on/off system (13) automatically closes the discharge solenoid valve (26) and opens the suction solenoid valve (25) and puts the vacuum unit (10A or 10B) back into operation temporarily for 2 minutes after unloading. Once the vacuum unit (10A or 10B) is turned off, the process can start over. In this way it is possible to remove the odors from the source and they are eliminated to the outside.

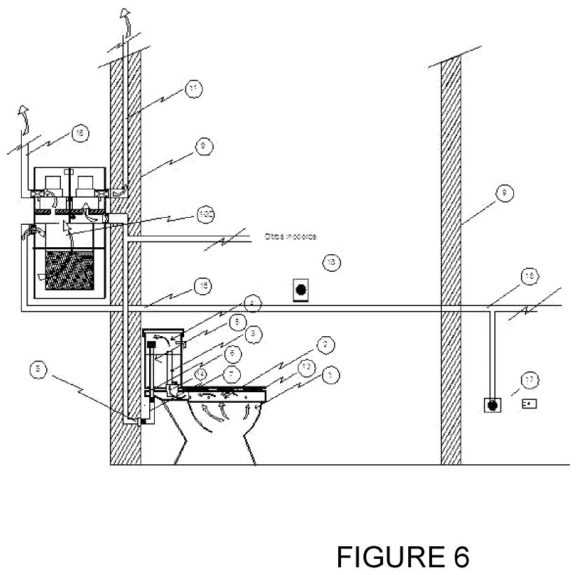

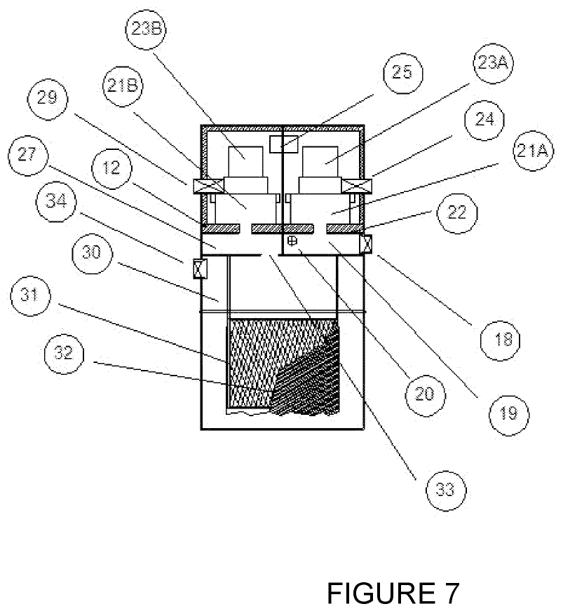

The Dust and Particle Absorption and Odor Extraction System (FIG. 6 and FIG. 7) consists of a core system that uses the basic concepts of the odor extraction system discussed in this document and the dust and particle absorption system. The disclosed system allows odor extraction from several toilets and absorption of dust and particles simultaneously.

The dual vacuum electric unit (FIG. 7) (10C) has two independent suction systems. One is dedicated exclusively to the extraction of odors and the other is dedicated exclusively to the absorption of dust and particles. Both systems use independent suction and discharge ducts, which allow the suction effect to be conducted to different points in the home.

The components of the Dual vacuum unit (10C) related to the extraction of odors are a high-rev electric motor (23A) and a vacuum turbine (21A), essential components to generate the suction effect and dedicated to the extraction of odors. odors, low pressure section called odor suction chamber (19), which transmits the vacuum effect to the odor suction (18), where the suction ducts (8) are connected, in the odor suction chamber also noise is controlled and suction control is performed by means of the pressure equalizing valve (20), which facilitates the passage of water through the discharge valve (14), during the discharge of water from the Cistern Tank (4). In the rear part of the odor suction turbine (21), the odor discharge area is located towards the air evacuation ducts (11), delivering the odors to the odor discharge (24). The odor extraction system of the dual vacuum unit (10C) is controlled by an on/off system (13).

The dust and particulate absorption system with the dual vacuum unit (FIG. 6 and FIG. 7) (10C), is an independent dust and particulate absorption system that has a high-rev electric motor (23B) and a turbine of vacuum (21 B), essential components to generate the suction effect and dedicated to the absorption of dust and particles, the suction effect is transmitted to the low pressure section called dust and particle suction chamber (27) and this transmits the suction effect to the cyclone tank (30) where the separation of dust and particles from the air stream occurs. The suction effect is transmitted from the cyclone tank (30) to the dust and particle suction ducts, through the dust and particle suction (34), the dust and particle suction ducts (34), are They are distributed throughout the house through the walls and a quick connection is installed at each end for vacuuming. By connecting the dust and particle absorption hose to the quick connection for vacuuming, the electrical circuit is closed, and the electric motor (23B) starts operating, thus activating the dust and particle absorption system.

Having made a description of the invention, which in no way has a limiting character in terms of what is referred to in the examples or in the graphs that are mentioned in it, and with which we seek to give a better understanding of it, we expose the characteristics of the invention to claim that, in the same way, when referring to the graphs, it does not do so with a limiting character but simply explanatory and clarifying.

1. An odor extraction system comprising:
a vacuum unit comprising a high-speed electric motor (16);
a vacuum turbine (18), which generates a low-pressure effect towards a suction (21), where suction ducts (8) are connected; and
an odor discharge zone at a rear side of the vacuum turbine (18) towards air evacuation ducts (11), passing through a discharge (23).

2. The odor extraction system of claim 1, further comprising an on/off system (13), the on/off system (13) is an automatic or a manual system, which controls the vacuum unit.

3. The odor extraction system of claim 1 wherein the vacuum unit is selected from an individual vacuum unit (10A) or a central vacuum unit (10B).

4. The odor extraction system of claim 3, wherein the vacuum unit corresponds to the central vacuum unit (10B) and comprises a suction chamber (15) that transmits the low-pressure effect to the suction (21).

5. The odor extraction system of claim 4, wherein the suction chamber comprises a pressure equalizing valve (20), which facilitates the passage of water through a discharge valve (14), during the discharge of water from a cisterna tank (4).

6. The odor extraction system of claim 5, further comprising a suction nozzle (6), which transmits the suction from the vacuum unit to the cistern tank (4) and has a height greater than a maximum water level (5) inside the cisterna tank (4).

7. The odor extraction system of claim 6, wherein the suction nozzle (6) comprises a vertical duct (G) that has a lower threaded end (A) that allows it to cross the bottom of the tank tank (4) and seal tight by tightening a nut (H) against a gasket (B);
wherein at an upper end of the vertical duct (G) is a suction head (D) in which the air that generates the vacuum inside the cisterna tank (4) is allowed to enter through an upper cover (E).

8. The odor extraction system of claim 1, further comprising a suction T (24), which allows alternating between the suction of odors and the discharge of water, and comprises a T-shaped duct that houses a solenoid valve suction valve (25), and a discharge solenoid valve (26), wherein the suction solenoid valve (25) opens and closes with the discharge of water and the discharge solenoid valve (26) opens on discharge.

9. An odor extraction and dust and particle absorption system comprising:
an odor extraction system and
a dust and particle absorption system;
wherein the odor extraction system comprises a dual vacuum electric unit (10C) comprising a high-speed electric motor (23A) and a vacuum turbine (21A); and
wherein the dust and particle absorption system comprises a high speed electric motor (23B) and a vacuum turbine (21B).

10. The system of claim 9, wherein the dual vacuum unit odor extraction system (10C) comprises a low-pressure section or an odor suction chamber (19) that transmits the vacuum effect to an odor suction (18) connected to suction ducts (8) and includes a pressure equalizing valve (20) that controls noise and performs suction control by regulating a discharge valve (14) during unloading from a cisterna tank (4).

11. The system of claim 9, wherein the dust and particle absorption system comprise a dust and particle suction chamber (27) that carries the dust to a cyclone tank (30) that separates the dust and particles from the air stream and disposes the dust in a dust and particle suction ducts (26).
